(19) United States
(12) Patent Application Publication
(10) Pub. No.: US 2013/0163235 A1
(43) Pub. Date: Jun. 27, 2013

(54) LED LAMP CAPABLE OF MULTILATERAL CONNECTION

(71) Applicant: Ukin Technology Co., Ltd, Taoyuan County (TW)

(72) Inventor: Tzu-Hsien Jessen CHUANG, Taoyuan County (TW)

(73) Assignee: UKIN TECHNOLOGY CO., LTD, Taoyuan County (TW)

(21) Appl. No.: 13/686,920

(22) Filed: Nov. 28, 2012

Related U.S. Application Data
(63) Continuation-in-part of application No. 13/332,410, filed on Dec. 21, 2011.

(51) Int. Cl. F21V 15/01; F21L 4/00

(52) U.S. Cl. CPC F21V 15/01; F21L 4/00
USPC 362/190; 362/364; 362/367

(57) ABSTRACT

A light-emitting diode (LED) lamp capable of multilateral connection includes a cuboidal housing having a plurality of light-permeable sides and a plurality of connecting sides adjacent to the light-permeable sides. The light-permeable sides are arranged in a C shape on the housing. The connecting sides are arranged in a C shape on the housing and are located where the light-permeable sides are absent. An LED module is provided in the housing, and the light emitted by the LED module can pass through the light-permeable sides. Each connecting side is provided with at least one fastening portion so that the housing and external similar housings can be assembled into a single unit of an arbitrary and changeable configuration through connection between the corresponding fastening portions of the housings, thus providing both convenience of use and fun.

### BACKGROUND OF THE INVENTION

1. Technical Field

The present invention provides a light-emitting diode (LED) lamp configured for multilateral connection. More particularly, the present invention relates to an LED lamp structure capable of connecting, both physically and electrically, with other similar structures in arbitrary and changeable configurations.

2. Description of Related Art

A conventional light-emitting diode (LED) lamp consists essentially of a housing, an LED module, and a lampshade. The LED module is installed in the housing. The lampshade is provided on the housing such that the LED module lies in the lampshade. A high-power high-voltage LED lamp generates considerable heat during operation, and the heat raises the temperature of the LED lamp, which however is detrimental to the service life of the LED lamp. To accelerate heat dissipation, such an LED lamp structure is additionally provided therein, and is connected, with a heat dissipation module.

Nowadays, both ordinary LED lamps and high-power high-voltage LED lamps use a single-housing structure; in other words, the LED module and the power source of an LED lamp of either kind are provided in the same housing. For example, the housing of a portable LED lamp typically provides receiving spaces for an LED module and a storage battery respectively, wherein the storage battery serves as the power source of the LED module. Taking a commercially available stationary LED lamp as another example, the LED module and the power source connecting portion (also known as a power connector) of the LED lamp are also provided in a single housing, wherein the power source connecting portion is electrically connected to the LED module and is electrically connectable to mains electricity through a power cord, so as for the LED module to be driven to emit light by mains electricity through the power cord and the power source connecting portion.

As the LED module and the power source (e.g., a storage battery or a power source connecting portion) of a conventional LED lamp are provided in one housing, it is impossible to separate the power source from the LED module. Hence, a user is not allowed to change the power source according to practical needs or the user's choice. For instance, during a power outage, a stationary lamp configured to be powered by mains electricity cannot be transformed into an emergency lighting tool by disassembling the lamp and directly connecting it to a storage battery. And because of that, one must prepare different types of lamps to suit different needs.

While there are LED lamps configured for double power sources, i.e., capable of being powered by either a storage battery or mains electricity, the battery receiving space in the housing of such an LED lamp cannot be removed when mains electricity is used as the power source, nor can the power connector or power cord for connecting with mains electricity be removed when a storage battery is used as the power source. That is to say, LED lamps of this type are relatively bulky.

In consideration of this, a more advanced LED lamp was developed which allows arbitrary and detachable connection between a plurality of such LED lamps, as disclosed in Taiwan Patent Nos. M428299U1 and M424433U1. Referring to FIGS. 10 and 11, the LED lamp structure disclosed in the afore-cited Taiwan patents mainly includes a housing, an LED module provided in the housing, a lampshade provided on a top portion of the housing, and a plurality of fastening portions, of a projecting or recessed configuration, peripherally provided on the outer walls of the housing, wherein the fastening portions enable detachable connection between plural such housings. However, this LED lamp structure is disadvantageous in that the LED module is allowed to project light through the lampshade in one direction only. When multiple such housings are to be connected, it is imperative to consider whether light will be blocked or be wastefully projected in unnecessary directions.

### BRIEF SUMMARY OF THE INVENTION

The primary object of the present invention is to provide an LED lamp structure which allows multiple similar structures to be physically and electrically connected together in arbitrary and changeable configurations, thereby overcoming the drawbacks of the prior art, namely the problem that a conventional LED lamp can project light through its lampshade in only one direction, and that therefore assembly of multiple such conventional LED lamps requires attention to be paid to whether light will be blocked or be wastefully cast in unnecessary directions.

To achieve the above object, the present invention provides an LED lamp capable of multilateral connection which includes:

a housing in the shape of a cuboid, the housing having a plurality of light-permeable sides and a plurality of connecting sides adjacent to the light-permeable sides, wherein the light-permeable sides are arranged in a C shape on the housing, and the connecting sides are arranged in a C shape on the housing and are located where the light-permeable sides are absent;

an LED module which is provided in the housing and whose light can pass through the light-permeable sides; and

at least one fastening portion on each connecting side so that the housing and external similar housings can be assembled into a single unit through connection between the corresponding fastening portions of the housings.

According to the above, multiple similar housings can be connected as a single unit by arbitrary engagement between the corresponding fastening portions, and the LED module in each of the multiple housings can emit light independently. Moreover, thanks to the plural light-permeable sides arranged in a C shape on each housing, the light emitted by the LED module in each housing can pass through the corresponding light-permeable sides in multiple directions. Thus, the problems of the conventional LED lamps, such as the unidirectional projection of light through the lampshade and the resulting need to consider whether light will be blocked or be wastefully cast in unnecessary directions when multiple housings are connected together, can be prevented.

The modes of implementing the present invention are further described as follows.

In addition to the aforesaid major technical features, each connecting side of the housing is provided with a conductive end electrically connected to the LED module. The conductive ends of the housing are configured for contacting with the conductive ends of external similar housings respectively.

In addition to the aforesaid major technical features, a storage battery is received in the housing and is electrically connected to the LED module so as to drive the LED module to emit light.

In addition to the aforesaid major technical features, the connecting sides of the housing are provided with a power source connecting portion for connecting with mains electricity, and the LED module is electrically connected to the power source connecting portion. Thus, the LED module can be driven to emit light by mains electricity through the power source connecting portion.

In addition to the aforesaid major technical features, a base is provided whose outer walls have a plurality of connecting sides. Each connecting side of the base is provided with at least one fastening portion and a conductive end. The connecting sides of the base are also provided with a power source connecting portion for connecting with mains electricity. The conductive ends of the base are electrically connected to the power source connecting portion of the base. With each connecting side of the housing having a conductive end electrically connected to the LED module, and the at least one fastening portion on a connecting side of the housing being connected with the at least one fastening portion on a connecting side of the base, a conductive end of the housing is in contact with a conductive end of the base, thus allowing the LED module to be driven to emit light by mains electricity through the power source connecting portion of the base, the conductive end of the base, and the conductive end of the housing.

Alternatively, a battery box is additionally provided whose outer walls have a plurality of connecting sides. Each connecting side of the battery box is provided with at least one fastening portion and a conductive end. A storage battery is received in the battery box and is electrically connected to the conductive ends of the battery box. With each connecting side of the housing having a conductive end electrically connected to the LED module, and the at least one fastening portion on a connecting side of the housing being connected with the at least one fastening portion on a connecting side of the battery box, a conductive end of the housing is in contact with a conductive end of the battery box, thus allowing the LED module to be driven to emit light by the storage battery through the conductive end of the battery box and the conductive end of the housing.

Alternatively, both a battery box and a base are additionally provided. The outer walls of the battery box have a plurality of connecting sides. Each connecting side of the battery box is provided with at least one fastening portion and a conductive end. A storage battery is received in the battery box and is electrically connected to the conductive ends of the battery box. The outer walls of the base have a plurality of connecting sides. Each connecting side of the base is provided with at least one fastening portion and a conductive end. The connecting sides of the base are also provided with a power source connecting portion for connecting with mains electricity. The conductive ends of the base are electrically connected to the power source connecting portion of the base. With each connecting side of the housing having a conductive end electrically connected to the LED module, and the at least one fastening portion on a connecting side of the housing being connected with the at least one fastening portion on a connecting side of the battery box, a conductive end of the housing is in contact with a first conductive end of the battery box, thus allowing the LED module to be driven to emit light by the storage battery through the first conductive end of the battery box and the conductive end of the housing. With the at least one fastening portion on another connecting side of the battery box being connected with the at least one fastening portion on a connecting side of the base, a second conductive end of the battery box is in contact with a conductive end of the base, thus allowing mains electricity to be supplied to the storage battery through the power source connecting portion of the base, the conductive end of the base, and the second conductive end of the battery box. Moreover, the LED module can be driven to emit light by the mains electricity through the power source connecting portion of the base, the conductive end of the base, the second and the first conductive ends of the battery box, and the conductive end of the housing.

In addition to the aforesaid major technical features, each fastening portion has a projecting or recessed configuration.

Alternatively, each fastening portion is a magnet or a metal plate.

In addition to the aforesaid major technical features, the connecting sides of each of the housing, the base, and the battery box may be provided with a power switch for turning on/off the LED module.

Hence, the present invention not only enables a user to connect together an arbitrary number of LED lamps of an arbitrary total voltage, but also allows a plurality of LED lamps to be arranged in arbitrary shapes.

### BRIEF DESCRIPTION OF THE SEVERAL VIEWS OF THE DRAWINGS

The structure as well as a preferred mode of use, further objects, and advantages of the present invention will be best understood by referring to the following detailed description of some illustrative embodiments in conjunction with the accompanying drawings, in which:

FIG. 1 is a perspective view of the first embodiment of the present invention;

FIG. 2 is an exploded perspective view of the embodiment shown in FIG. 1;

FIG. 3 is a perspective view of the second embodiment of the present invention;

FIG. 4 is a perspective view of the third embodiment of the present invention;

FIG. 5 is an exploded perspective view of the embodiment shown in FIG. 4;

FIG. 6 is a perspective view of an assembled multiple-piece configuration of the embodiment shown in FIG. 4;

FIG. 7 is a perspective view of the fourth embodiment of the present invention;

FIG. 8 is a perspective view of the fifth embodiment of the present invention;

FIG. 9 is a perspective view of an assembled multiple-piece configuration of the embodiment shown in FIG. 8;

FIG. 10 is a perspective view of a prior art device; and

FIG. 11 is a perspective view of another prior art device.

### DETAILED DESCRIPTION OF THE INVENTION

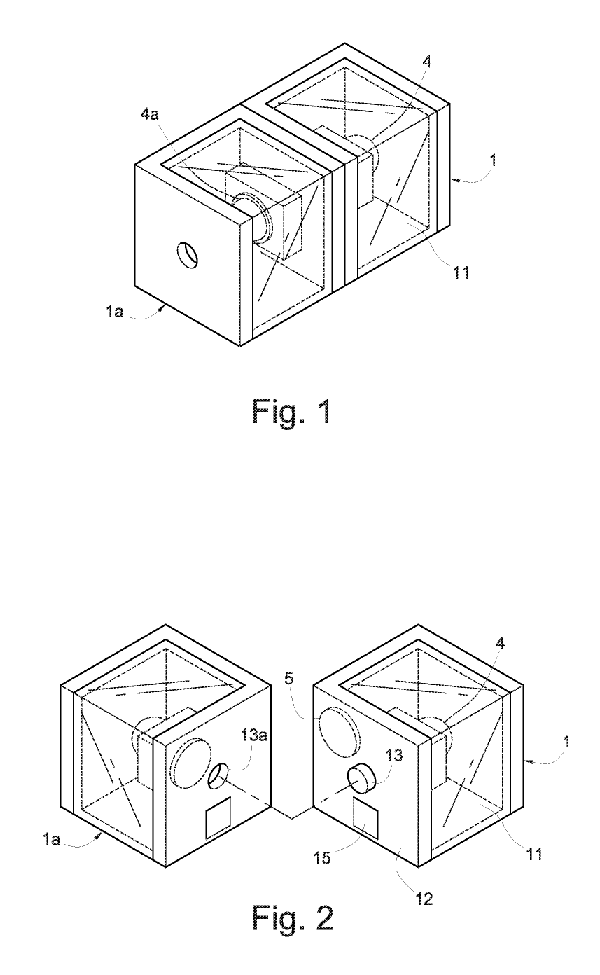

Please refer to FIG. 1 for the first embodiment of the present invention and FIG. 2 for an exploded perspective view of the embodiment shown in FIG. 1. As shown in FIGS. 1 and 2, an LED lamp capable of multilateral connection according to the present invention includes a housing 1, an LED module 4, and at least one fastening portion 13.

The housing 1 is cuboidal and has a plurality of light-permeable sides 11, which serve as a lampshade, and a plurality of connecting sides 12 adjacent to the light-permeable sides 11. The light-permeable sides 11 are arranged in a C shape on the housing 1. The connecting sides 12 are arranged in a C shape on the housing 1 and are located where the light-permeable sides 11 are absent.

The connecting sides 12 may be integrally formed with the light-permeable sides 11 and hence be light-permeable. The connecting sides 12 may also be made of a non-light-permeable material and therefore block passage of light. The housing in this embodiment is cube-shaped and has three light-permeable sides 11 arranged in a C shape and three connecting sides 12 arranged in a C shape.

The LED module 4 is provided in the housing 1, and the light emitted by the LED module 4 can pass through the light-permeable sides 11.

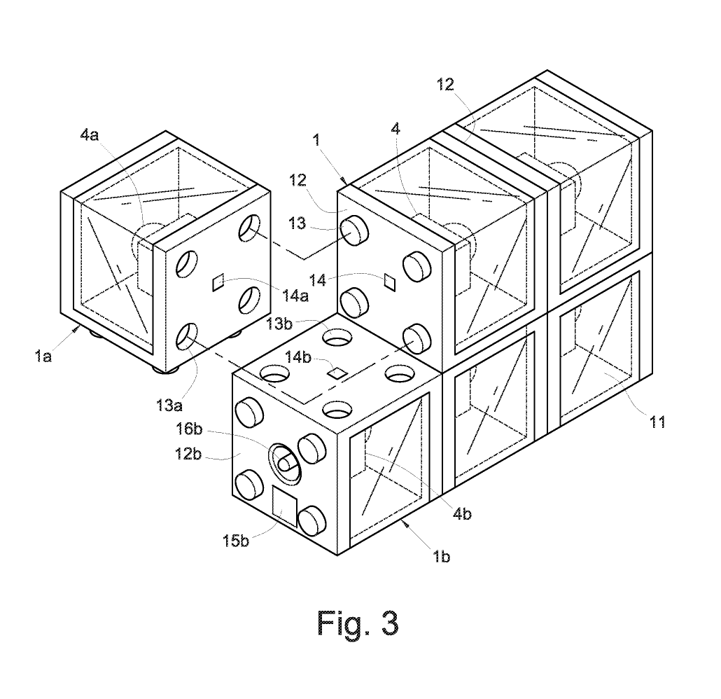

Each connecting side 12 is centrally or peripherally (see FIG. 3) provided with at least one fastening portion 13. The fastening portions 13 of the housing 1 correspond to the fastening portions 13a of another housing 1a so that the housing 1 and the external housing 1a can be assembled into a single unit through connection between the corresponding fastening portions 13, 13a.

The fastening portions 13, 13a may have a projecting configuration and a recessed configuration respectively. In this embodiment, the fastening portions 13 of the housing 1 are of a projecting configuration, and the fastening portions 13a of the external housing 1a are of a recessed configuration. Each projecting fastening portion 13 is engageable in a corresponding recessed fastening portion 13a. Alternatively, the fastening portions 13, 13a may be magnets or metal plates capable of being attracted to magnets. For example, both fastening portions 13, 13a are magnets, or the fastening portions 13 are magnets while the fastening portions 13a are metal plates. Thus, the fastening portions 13, 13a are connectable to each other to enable connection between the housings 1, 1a.

A storage battery 5 is received in the housing 1, 1a and is electrically connected to the LED module 4 so as to drive the LED module 4 to emit light. In addition, a power switch 15 is provided on the connecting sides 12 of the housing 1, 1a and is electrically connected between the LED module 4 and the storage battery 5. By triggering the power switch 15, the LED module 4 can be turned on or off to emit light or not emit light.

According to the above, a plurality of housings 1, 1a can be arbitrarily connected together by means of the fastening portions 13, 13a such that the housings 1, 1a form a single unit, wherein the LED module 4 in each housing 1, 1a can emit light independently.

Thanks to the structural design of the fastening portions 13, 13a of the present invention, the housings 1, 1a of a plurality of LED lamps having the same structure can be connected together in a way similar to toy building blocks. A user may connect an arbitrary number of such LED lamps according to practical needs and may change the total voltage of the connected LED lamps by adjusting the number of the LED lamps used. The physical appearance and size of the connected LED lamps may also be changed by varying the number of the LED lamps used and the way in which the LED lamps are connected. Thus, an assembly of LED lamps that best suits the user's needs can be easily obtained through free adjustments. Once the decorations surrounding the assembly are altered, the assembly can be disassembled and reassembled with the same ease. Moreover, when there is a need for a temporary light source, some of the LED lamps can be detached from the assembly for use and put back in place after use. As such, convenience of use is achieved with a touch of fun.

Besides, with the light-permeable sides 11 being arranged in a C shape on the housing 1, the light emitted by the LED module 4 will shine through the light-permeable sides 11 in multiple directions. Consequently, the drawbacks of the prior art, such as the lampshade design that allows light projection in only one direction and the resulting need to consider whether light will be blocked or be wastefully cast in unnecessary directions when multiple housings are assembled together, can be prevented.

Please refer to FIG. 3 for a perspective view of the second embodiment of the present invention. The second embodiment is different from the first embodiment in that each of the plural connecting sides 12 of the housing 1 is provided with a metallic conductive end 14 electrically connected to the LED module 4. When the housings 1, 1a are connected together, a conductive end 14 of the housing 1 is in contact with a conductive end 14a of the housing 1a. This allows the LED module 4a in the housing 1a to be driven to emit light by the storage battery 5 in the housing 1 by way of the conductive ends 14, 14a that are in contact with each other.

As shown in FIG. 3, the connecting sides 12b of the housing 1b are provided with a power source connecting portion 16b for connecting with mains electricity, and the LED module 4b in the housing 1b is electrically connected to the power source connecting portion 16b. Thus, by way of the power source connecting portion 16b, mains electricity can be used to drive the LED module 4b in the housing 1b to emit light. When the housings 1, 1a, 1b are connected together by the corresponding fastening portions 13, 13a, 13b, the LED modules 4, 4a, 4b respectively in the housings 1, 1a, 1b are electrically connected by the corresponding conductive ends 14, 14a, 14b and can therefore be driven to emit light simultaneously by mains electricity through the power source connecting portion 16b and the corresponding conductive ends 14, 14a, 14b. Further, a user may operate the power switch 15b on the housing 1b to turn on or off the LED modules 4, 4a, 4b such that the LED modules 4, 4a, 4b are triggered to emit light or stopped from emitting light. All the remaining elements of, and the mode of implementing, the second embodiment are the same as those of the first embodiment.

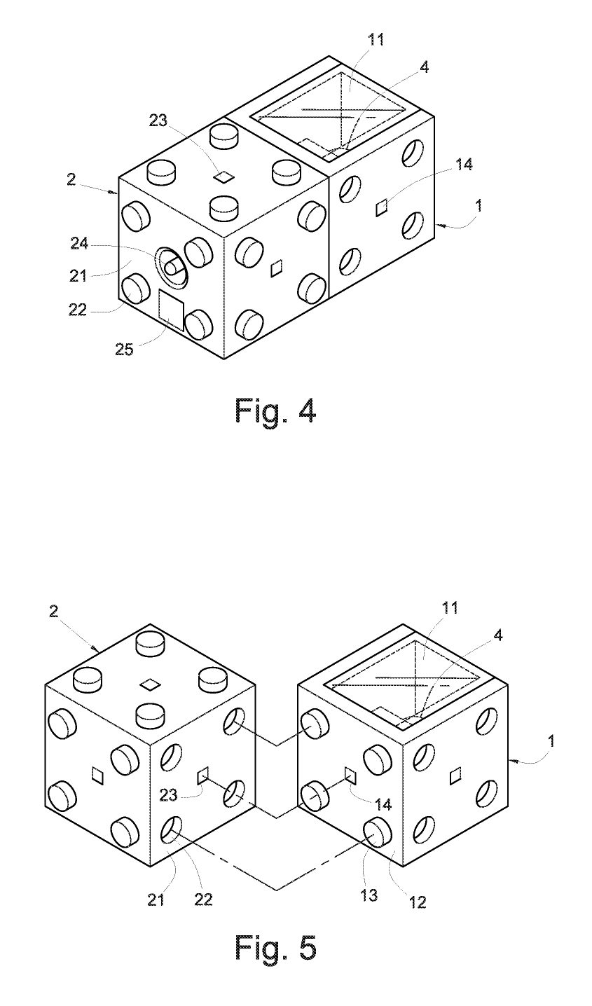

FIG. 4 shows a perspective view of the third embodiment of the present invention, and FIG. 5 is an exploded perspective view of the embodiment in FIG. 4. As shown in FIGS. 4 and 5, the third embodiment is different from the first embodiment in that a base 2 is additionally provided. The base 2 in this embodiment may have a cube shape.

The outer walls of the base 2 have a plurality of connecting sides 21, and each connecting side 21 of the base 2 is provided with at least one fastening portion 22 and a conductive end 23. The connecting sides 21 of the base 2 are also provided with a power source connecting portion 24 for connecting with mains electricity. The conductive ends 23 of the base 2 are electrically connected to the power source connecting portion 24. The fastening portions 22 of the base 2 are of a projecting or recessed configuration. Alternatively, the fastening portions 22 may be magnets or metal plates.

The connecting sides 21 of the base 2 are further provided with a power switch 25. The fastening portions 13 of the housing 1 can be connected with the fastening portions 22 of the base 2, thus bringing a conductive end 14 of the housing 1 into contact with a conductive end 23 of the base 2, allowing the LED module 4 to be driven to emit light by mains electricity through the power source connecting portion 24, the conductive end 23 of the base 2, and the conductive end 14 of the housing 1. Also, the LED module 4 can be turned on or off with the power switch 25 so as to emit light or not emit light.

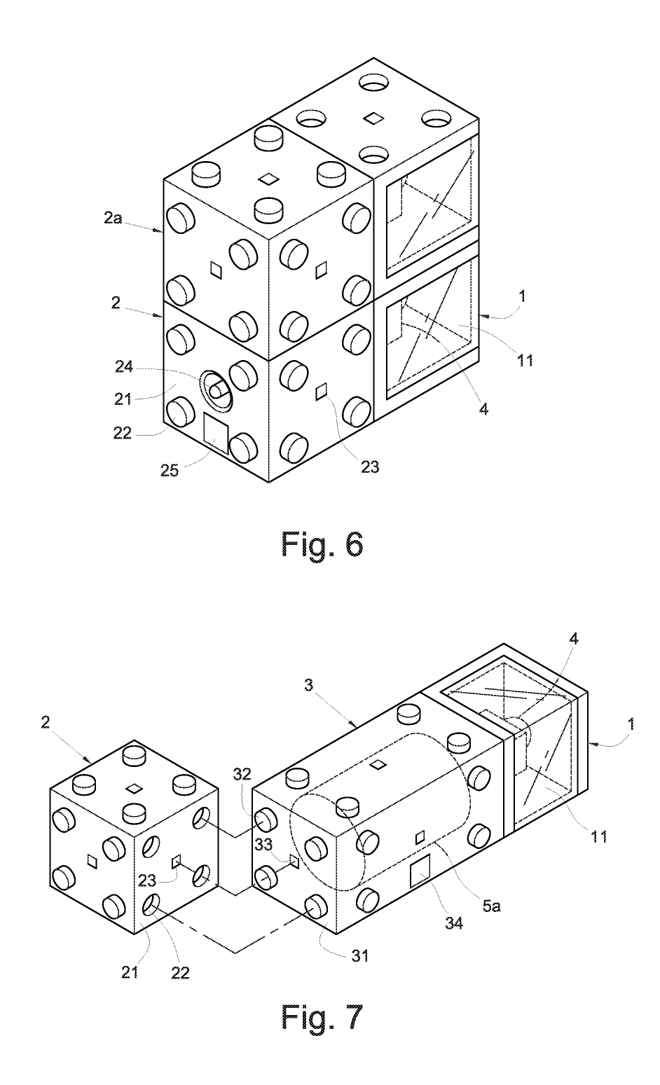

FIG. 6 is a perspective view of an assembled multiple-piece configuration of the embodiment depicted in FIG. 4, showing how a plurality of bases 2, 2a and a plurality of housings 1 can be assembled into a single unit. All the remaining elements of, and the mode of implementing, this embodiment are the same as those of the previous embodiments.

The fourth embodiment of the present invention is shown in FIG. 7 in a perspective view. The fourth embodiment differs from the first embodiment in that a battery box 3 is additionally provided. The battery box 3 in this embodiment may take the shape of a rectangular parallelepiped.

The outer walls of the battery box 3 have a plurality of connecting sides 31. Each connecting side 31 of the battery box 3 is provided with at least one fastening portion 32 and a conductive end 33. A storage battery 5a is received in the battery box 3 and is electrically connected to the conductive ends 33 of the battery box 3.

The fastening portions 13 of the housing 1 are connectable with the fastening portions 32 of the battery box 3 so that a conductive end 14 of the housing 1 is in contact with a conductive end 33 of the battery box 3. Thus, by way of the conductive end 33 of the battery box 3 and the conductive end 14 of the housing 1, the storage battery 5a can drive the LED module 4 to emit light.

The connecting sides 31 of the battery box 3 may also be provided with a power switch 34 electrically connected between the storage battery 5a and the conductive ends 33. By switching the power switch 34, the LED module 4 can be turned on or off to emit light or not emit light. All the remaining elements of, and the mode of implementing, the fourth embodiment are the same as those of the previous embodiments.

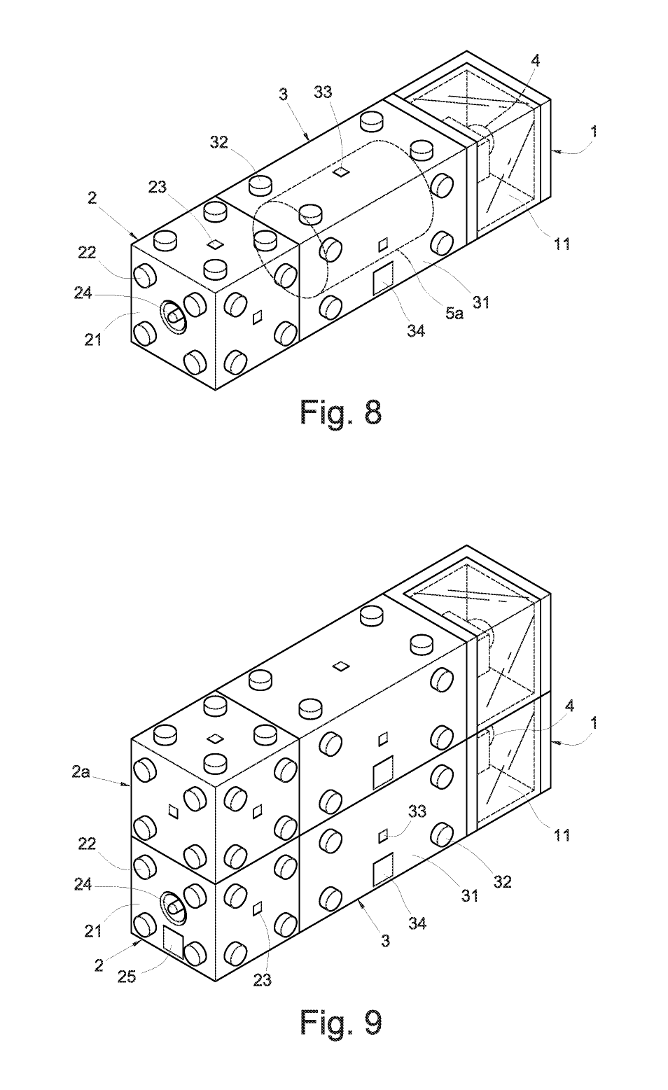

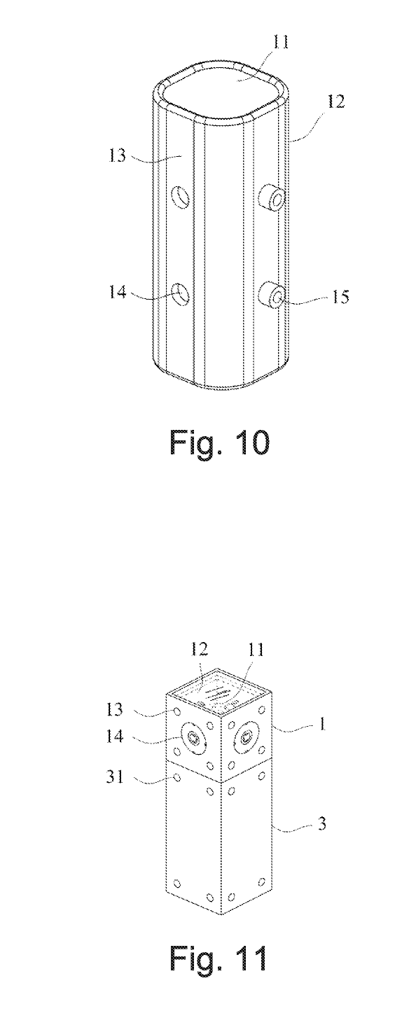

FIG. 8 shows the fifth embodiment of the present invention in a perspective view. Referring to FIG. 8 in conjunction with FIG. 7, the fifth embodiment is different from the first embodiment in the following. First of all, some fastening portions 13 of the housing 1 are connected with some fastening portions 32 of the battery box 3 such that a conductive end 14 of the housing 1 is in contact with a conductive end 33 (say, a first conductive end 33) of the battery box 3. This allows the LED module 4 to be driven to emit light by the storage battery 5a through the first conductive end 33 of the battery box 3 and the conductive end 14 of the housing 1.

Further, some other fastening portions 32 of the battery box 3 are connected with some fastening portions 22 of the base 2 such that another conductive end 33 (say, a second conductive end 33) of the battery box 3 is in contact with a conductive end 23 of the base 2. Thus, under the control of the power switch 25 or 34 (see FIG. 9), not only can mains electricity be supplied to the storage battery 5a via the power source connecting portion 24, the conductive end 23 of the base 2, and the second conductive end 33 of the battery box 3, but also the LED module 4 can be driven to emit light by the mains electricity through the power source connecting portion 24, the conductive end 23 of the base 2, the second and the first conductive ends 33 of the battery box 3, and the conductive end 14 of the housing 1. All the remaining elements of, and the mode of implementing, the fifth embodiment are the same as those of the previous embodiments.

FIG. 9 shows a perspective view of an assembled multiple-piece configuration of the embodiment depicted in FIG. 8, demonstrating how a plurality of bases 2, 2a, a plurality of battery boxes 3, and a plurality of housings 1 can be assembled into a single unit. All the remaining elements of, and the mode of implementing, this embodiment are the same as those of the previous embodiments.

According to the above, the LED lamp of the present invention may be built-in with the storage battery 5a, which is provided in the battery box 3. The power source connecting portion 24 at a bottom portion of the base 2 can be connected with 110V mains electricity so as to charge the storage battery 5a in the battery box 3. Further, the power switch 34 on an outer wall of the battery box 3 can be used to start or stop light emission of the LED module 4. In addition, by connecting a plurality of such LED lamps together in a way similar to toy building blocks, series or parallel connection of the LED modules 4, 4a, 4b can be achieved.

The present invention has the following advantages over the prior art:

1. The LED lamp of the present invention is so configured that a plurality of such LED lamps can be connected together in a way similar to toy building blocks. The physical appearance and size of the resulting assembly can be changed by varying the number of the LED lamps used and the manner in which the LED lamps are connected.

2. The building block-like LED lamp of the present invention is so configured that the total voltage of an assembly of multiple such LED lamps can be changed by adjusting the number of the LED lamps used. This allows the user to obtain the desired assembly of LED lamps easily.

3. The building block-like LED lamp of the present invention is so configured that, when the decorations surrounding an assembly of multiple such LED lamps are changed, the assembly can be directly disassembled and then reassembled as appropriate. Moreover, when in need of a makeshift light source, some of the LED lamps in the aforesaid assembly can be temporarily detached for use. Thus, the present invention features both convenience of use and fun.

4. With the light-permeable sides 11 being arranged in a C shape on the housing 1, the light of the LED module 4 can shine through the light-permeable sides 11 in multiple directions, which adds significantly to the degree of freedom in connecting a plurality of housings 1.

What is claimed is:

1. A light-emitting diode (LED) lamp capable of multilateral connection, comprising:
a housing of a cuboid shape, the housing having a plurality of light-permeable sides and a plurality of connecting sides adjacent to the light-permeable sides, the light-permeable sides being arranged in a C shape on the housing, the connecting sides being arranged in a C shape on the housing and located where the light-permeable sides are absent;
an LED module provided in the housing such that light emitted by the LED module can pass through the light-permeable sides; and
at least one fastening portion on each said connecting side so that the housing and external said housings can be assembled into a single unit through connection between corresponding said fastening portions of the housings.

2. The LED lamp of claim 1, wherein each said connecting side of the housing is provided with a conductive end electrically connected to the LED module, and the conductive ends of the housing are configured for contacting with said conductive ends of external said housings respectively.

3. The LED lamp of claim 1, wherein the housing receives therein a storage battery electrically connected to the LED module, so as for the storage battery to drive the LED module to emit light.

4. The LED lamp of claim 1, wherein the connecting sides of the housing are provided with a power source connecting portion for connecting with mains electricity, and the LED module is electrically connected to the power source connecting portion, so as for the LED module to be driven to emit light by the mains electricity through the power source connecting portion.

5. The LED lamp of claim 1, further comprising a base whose outer walls have a plurality of connecting sides, each said connecting side of the base being provided with at least one fastening portion and a conductive end, the connecting sides of the base being further provided with a power source connecting portion for connecting with mains electricity, the conductive ends of the base being electrically connected to the power source connecting portion of the base, each said connecting side of the housing being provided with a conductive end electrically connected to the LED module, wherein when the at least one fastening portion on a said connecting side of the housing is connected with the at least one fastening portion on a said connecting side of the base, a said conductive end of the housing is in contact with a said conductive end of the base, thus allowing the LED module to be driven to emit light by the mains electricity through the power source connecting portion of the base, the conductive end of the base, and the conductive end of the housing.

6. The LED lamp of claim 1, further comprising a battery box whose outer walls have a plurality of connecting sides, each said connecting side of the battery box being provided with at least one fastening portion and a conductive end, the battery box receiving therein a storage battery electrically connected to the conductive ends of the battery box, each said connecting side of the housing being provided with a conductive end electrically connected to the LED module, wherein when the at least one fastening portion on a said connecting side of the housing is connected with the at least one fastening portion on a said connecting side of the battery box, a said conductive end of the housing is in contact with a said conductive end of the battery box, thus allowing the LED module to be driven to emit light by the storage battery through the conductive end of the battery box and the conductive end of the housing.

7. The LED lamp of claim 1, further comprising a battery box and a base, the battery box having outer walls having a plurality of connecting sides, each said connecting side of the battery box being provided with at least one fastening portion and a conductive end, the battery box receiving therein a storage battery electrically connected to the conductive ends of the battery box, the base having outer walls having a plurality of connecting sides, each said connecting side of the base being provided with at least one fastening portion and a conductive end, the connecting sides of the base being further provided with a power source connecting portion for connecting with mains electricity, the conductive ends of the base being electrically connected to the power source connecting portion of the base, each said connecting side of the housing being provided with a conductive end electrically connected to the LED module, wherein when the at least one fastening portion on a said connecting side of the housing is connected with the at least one fastening portion on a said connecting side of the battery box, a said conductive end of the housing is in contact with a first said conductive end of the battery box, thus allowing the LED module to be driven to emit light by the storage battery through the first conductive end of the battery box and the conductive end of the housing, and when the at least one fastening portion on another said connecting side of the battery box is further connected with the at least one fastening portion on a said connecting side of the base, a second said conductive end of the battery box is in contact with a said conductive end of the base, thus allowing the mains electricity to be supplied to the storage battery through the power source connecting portion of the base, the conductive end of the base, and the second conductive end of the battery box; and the LED module to be driven to emit light by the mains electricity through the power source connecting portion of the base, the conductive end of the base, the second conductive end of the battery box, the first conductive end of the battery box, and the conductive end of the housing.

8. The LED lamp of claim 1, wherein each said fastening portion is of a projecting or recessed configuration.

9. The LED lamp of claim 5, wherein each said fastening portion is of a projecting or recessed configuration.

10. The LED lamp of claim 6, wherein each said fastening portion is of a projecting or recessed configuration.

11. The LED lamp of claim 7, wherein each said fastening portion is of a projecting or recessed configuration.

12. The LED lamp of claim 1, wherein each said fastening portion is a magnet or a metal plate.

13. The LED lamp of claim 5, wherein each said fastening portion is a magnet or a metal plate.

14. The LED lamp of claim 6, wherein each said fastening portion is a magnet or a metal plate.

15. The LED lamp of claim 7, wherein each said fastening portion is a magnet or a metal plate.

16. The LED lamp of claim 1, wherein at least one said connecting side is provided with a power switch for turning on/off the LED module.

17. The LED lamp of claim 5, wherein at least one said connecting side is provided with a power switch for turning on/off the LED module.

18. The LED lamp of claim 6, wherein at least one said connecting side is provided with a power switch for turning on/off the LED module.

19. The LED lamp of claim 7, wherein at least one said connecting side is provided with a power switch for turning on/off the LED module.
